(19) United States
(12) Patent Application Publication
(10) Pub. No.: US 2006/0287975 A1
(43) Pub. Date: Dec. 21, 2006

(54) Time frame system

(76) Inventor: Melanie Posner, Massapequa, NY (US)

Correspondence Address: WEISS & WEISS;Suite 251, 300 Old Country Road, Mineola, NY, 11501, US

(21) Appl. No.: 11/455,342

(22) Filed: Jun. 19, 2006

Related U.S. Application Data
(60) Provisional application No. 60/692,223, filed on Jun. 20, 2005.

(51) Int. Cl. G06F 17/30

(52) U.S. Cl. 707/1

(57) ABSTRACT

The present invention relates to custom software and hardware specifically designed to deliver interactive information in a public space.

### FIELD OF THE INVENTION

The present invention relates to custom software and hardware specifically designed to deliver interactive information in a public space.

### BACKGROUND OF THE INVENTION

In the prior art, people who wanted to post information in a public space, posted a non-interactive sign or pictures or pamphlets providing the user the information. In order for the information to be updated the sign, picture or pamphlet had to be replaced. Further this information was not provided in an interactive format so that a user could ask questions and receive the correct information.

### SUMMARY OF THE INVENTION

The present invention relates to a custom software and hardware specifically designed to deliver interactive information in a public space. The software is database driven. All applications can be searched dynamically and configured to display information in a number of ways. The hardware is a combination of existing or custom built large format display devices. It is an object of the present invention for the device to be enabled by touch screen, dynamic and non-interactive capability.

It is an object of the present invention to provide a device for providing interactive information to a person in a mall. The information can consist of location of stores, information concerning the stores, such as operating hours, and more detailed items such as the products and services provided by each store in the mall. The information can also provide step by step directions to each store.

It is an object of the present invention to provide the system of the present invention for use in a gym. It is an object of the present invention to a allow a gym owner to provide information on an interactive computer system so that a user can see all of the current events going on at the gym and so that the user can seek the specific information that they require.

It is an object of the present invention to include synchronization with a website. It is an object of the present invention to include advertisements or space to license out to advertisers. It is an object of the present invention to include a “virtual personal trainer” to help modify the workout programs of the members. It is an object of the present invention to provide additional nutritional advice based on fitness goals of the members. It is an object of the present invention for the device to act as a medium for the business to keep in touch with it's clients.

The present invention relates to a digital interactive touch screen display, which has a text graphics, such as location based text graphics, user interface. It is an object of the present invention for a user to be able to navigate location based specific schedule promotions and information.

It is an object of the present invention to comprise a multiple sized LCD, Plasma, Projection, or other visual display devices. It is an object of the present invention to provide a touch interface consisting of resistive, capacitive, SAW optical or any other touch sensitive system. It is an object of the present invention to comprise a computer device capable of providing suitable graphics. It is an object of the present invention for the system to comprise windows, linux, unix, mac or other operating systems.

It is an object of the present invention for the software programs to accommodate retrieving times and dates, names, images, video clips, animation, or other visually displayed information. It is an object of the present invention for the system to have a control interface for an end user to edit information easily. It is an object of the present invention for the software to use a web based module for ease of end user operation.

It is an object of the present invention for the software to have forms that enable a user to input dates and edit future programming. It is an object of the present invention for the system to be an Intranet or Internet based communication system for network data transfer. It is an object of the present invention for the system to comprise a printing interface to print information. It is an object of the present invention for the device to comprise a wall stand or kiosk mounting system to support the unit.

It is an object of the present invention for the system to provide to the user: class schedules, instructor information, class information, fitness trainer availability, multiple locations and class information for other locations, header for gym location and operation times, and any other information that the customer desires at a custom integration level.

It is an object of the present invention for the databases to assign levels of priority to various pieces of information for time sensitivity.

It is an object of the present invention when the device is not being used to revert to displaying advertisements, time or stock sensitive information.

It is an object of the present invention for the system to provide to the system administration a comprehensive editing system for entering and altering data within the database. It is an object of the present invention for the system administration to view a history of all items and activities of each user session and provide information to the user.

### BRIEF DESCRIPTION OF THE DRAWINGS

FIG. 1 is a illustration of a web-based management and reporting system.

### DETAILED DESCRIPTION OF THE INVENTION

In an embodiment, the system of the present invention comprises an LCD size of choice, and an LCD touch overlay. The hardware for the system further comprises computer hardware, a wired mouse, wired keyboard, wires and interconnects and a connection from the LCD to the computer. The system can be wall mounted or desk mounted.

In a preferred embodiment, the system has a wireless keyboard and wireless mouse with a keyboard/trackpad combo or any other wireless form of communication. The system further comprises a data transfer dongle, UPS back up, and a surge protector.

In an embodiment, the software and graphics provide a calendar by week, location hours of operation information, class category menu, class type menu, instructor information, and class location information. The software further provides a start over button, monitor shut down, and basic search capabilities. The software also provide the time until the next class, an information ticker, picture insertion function, class profiles, and class intensity levels. The software also allows all of this information to be printed.

In a preferred embodiment, the software/graphics include a Calendar by day/month custom skin, video insertion and editing, photo insertion and editing, data entry, web site integration, class sign up function, web site design, web site hosting, and domain name registration.

In a preferred embodiment the system can display full motion graphics based on preset schedules, user direction, system administration direction, or interfacing with other extraneous systems such as, point of sale or inventory systems.

### DESCRIPTION OF THE PREFERRED EMBODIMENTS

The present invention is described in detail with reference to the attached drawings.

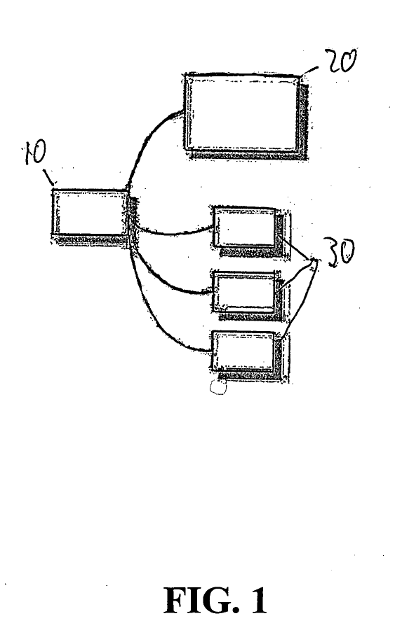

FIG. 1 shows a web-based management and reporting system 10, which can comprise a large format interactive display 20 and/or dynamic broadcasts networks 30. The large formal interactive display 20, can comprise multiple sizes of between 24 and 40″. It further comprises a touch sensitive LCD with very low physical foot printing and highly engaging. The dynamic broadcast network 30 can comprise multiple sizes screens from approximately 15-20″. The dynamic broadcast network 30 has a flexible installation and is hot swappable. The dynamic broadcast network has a dynamic display of data.

1. A system designed for delivering interactive information in a public space comprising:
a database driven software;
hardware comprising a combination of existing or custom built large format display devices having dynamic, non-interactive and touch screen capability;
said system being able to be searched dynamically and configured to display information in several different ways.

2. The system of claim 1 wherein said software contains information for a mall comprising location of stores, information concerning said stores, including operating hours, and products and services provided by each store in said mall and step by step directions to each of said stores.

3. The system of claim 1 wherein said system is for use in a gym and said system comprises:
an interactive computer system so that a user can see current events going on at said gym and so said user can seek specific information that they require.

4. The system of claim 1 further comprising synchronization with a website.

5. The system of claim 1 further comprising:
advertisements or space to license out to advertisers.

6. The system of claim 3 further comprising a virtual personal trainer to help modify workout programs of members.

7. The system of claim 3 further comprising information regarding additional nutritional advice based on fitness goals of members.

8. The system of claim 1 wherein said display device comprises a multiple sized LCD, Plasma, or Projection device.

9. The system of claim 1 further comprising a wall stand or kiosk mounting system to support said system.

10. The system of claim 3 wherein said information comprises class schedules, instructor information, class information, fitness trainer availability, multiple locations and class information for other locations, header for gym location and operation times.

11. The system of claim 1 wherein said software allows information to be printed.

12. The system of claim 1 wherein said system comprises a digital interactive touch screen display, which has text graphics, and allows a user to navigate location based specific schedule promotions and information.

13. The system of claim 1 wherein said database assigns levels of priority to various pieces of information for time sensitivity.

14. The system of claim 1 wherein when said system is not in use; said system displays advertisements, time or stock sensitive information.

15. The system of claim 1 wherein said system provides history of all items and activities of each user session.
